(19) United States
(12) Patent Application Publication
(10) Pub. No.: US 2025/0078455 A1
(43) Pub. Date: Mar. 6, 2025

(54) TRAINING APPARATUS, TRAINING METHOD, AND NON-TRANSITORY COMPUTER-READABLE STORAGE MEDIUM

(71) Applicant: KABUSHIKI KAISHA TOSHIBA, Tokyo (JP)

(72) Inventors: Shun HIRAO, Kawasaki Kanagawa (JP); Shuhei NITTA, Tokyo (JP)

(73) Assignee: KABUSHIKI KAISHA TOSHIBA, Tokyo (JP)

(21) Appl. No.: 18/760,023

(22) Filed: Jul. 1, 2024

(30) Foreign Application Priority Data
Sep. 5, 2023 (JP) 2023-143922

(51) Int. Cl. G06V 10/762; G06V 10/44

(52) U.S. Cl. CPC G06V 10/762; G06V 10/44

(57) ABSTRACT

According to one embodiment, a training apparatus includes processing circuitry. The processing circuitry acquires a plurality of items of subject data and a target cluster number, iteratively trains a learning model on the plurality of items of subject data by unsupervised learning based on learning conditions, estimates a feature cluster number based on a plurality of feature vectors corresponding to the plurality of items of subject data, and updates the learning conditions based on the feature cluster number and the target cluster number.

### CROSS-REFERENCE TO RELATED APPLICATION

This application is based upon and claims the benefit of priority from Japanese Patent Application No. 2023-143922, filed Sep. 5, 2023, the entire contents of which are incorporated herein by reference.

### FIELD

Embodiments described herein relate generally to a training apparatus, a training method, and a non-transitory computer-readable storage medium.

### BACKGROUND

Conventionally, in machine learning, unsupervised learning has been known as a learning technique in which subject data is learned without being tagged with classification labels as correct data. In unsupervised learning, since classification labels are unknown, the subject data may be classified into a number of clusters reflecting features of the subject data. In unsupervised learning, the subject data may be classified into a varying number of clusters according to the learning conditions. There is thus a possibility that results of unsupervised learning may not be necessarily preferable for the user, with the number of clusters exceeding a range that can be expected by the user.

Under the circumstances, there has been a demand in unsupervised learning for classifying subject data into a target cluster number. There is a case where an approximate number of categories under which inspection images are classified is known; for example, there may be a case where there are on the order of 10 classes of defective patterns. In CIFAR-10, which is an image dataset of 10 types of objects (such as vehicles and animals), there are, for example, demands for classifying images under two classes (vehicles and animals), and for classifying images into 100 classes, which is more narrowly than the 10 classes that are generally adopted, in consideration of the color, size, etc. However, a training apparatus capable of training a model suitable for classification into a target cluster number to meet such demands has not been known.

### BRIEF DESCRIPTION OF THE DRAWINGS

FIG. 1 is a block diagram illustrating a configuration of a training apparatus according to an embodiment.

FIG. 2 is a block diagram illustrating a specific configuration of a training unit shown in FIG. 1.

FIG. 3 is a block diagram illustrating a specific configuration of a loss calculation unit shown in FIG. 2.

FIG. 4 is a flowchart illustrating an operation of the training apparatus according to the embodiment.

FIG. 5 shows scatter charts in which feature vectors obtained by changing a first temperature parameter are visualized according to the embodiment.

FIG. 6 shows scatter charts in which feature vectors obtained by changing a second temperature parameter are visualized according to the embodiment.

FIG. 7 shows scatter charts in which feature vectors obtained by changing a balancing parameter are visualized according to the embodiment.

FIG. 8 shows an example of display data including a scatter chart in which feature vectors are visualized and a group of representative images of each cluster according to the embodiment.

FIG. 9 is a block diagram illustrating a hardware configuration of a computer according to the embodiment.

### DETAILED DESCRIPTION

In general, according to one embodiment, a training apparatus includes processing circuitry. The processing circuitry acquires a plurality of items of subject data and a target cluster number, iteratively trains a learning model on the plurality of items of subject data by unsupervised learning based on learning conditions, estimates a feature cluster number based on a plurality of feature vectors corresponding to the plurality of items of subject data, and updates the learning conditions based on the feature cluster number and the target cluster number.

Hereinafter, an embodiment of a training apparatus will be described in detail with reference to the accompanying drawings. In the embodiment, a machine learning model will be described, as an example, in which an image data group (an image dataset) containing images of a plurality of types of subjects such as vehicles and animals are clustered by unsupervised learning. It is assumed, for example, that a neural network is employed for machine learning. That is, the learning model of the embodiment is a neural network model.

### Embodiment

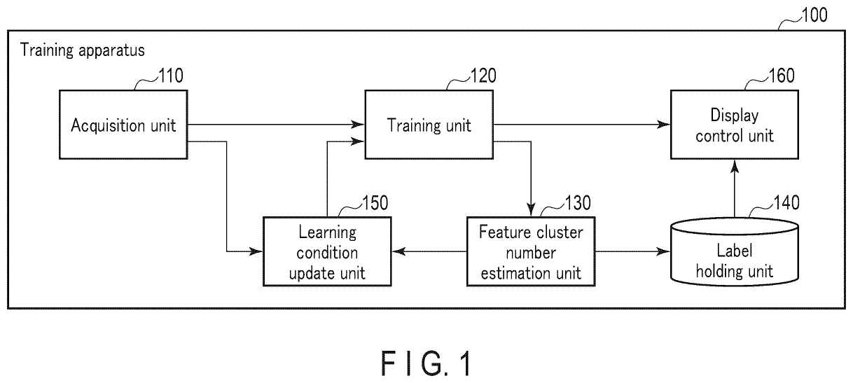

FIG. 1 is a block diagram illustrating a configuration of a training apparatus 100 according to the embodiment. The training apparatus 100 is a computer for generating a trained model by training a machine learning model by unsupervised learning. The training apparatus 100 includes an acquisition unit 110, a training unit 120, a feature cluster number estimation unit 130, a label holding unit 140, a learning condition update unit 150, and a display control unit 160.

The acquisition unit 110 acquires a plurality of items of subject data, a target cluster number, and learning conditions. The acquisition unit 110 outputs the plurality of items of subject data and the learning conditions to the training unit 120, and outputs the target cluster number and the learning conditions to the learning condition update unit 150. The learning conditions acquired by the acquisition unit 110 may be referred to as “initial learning conditions”. The initial learning conditions may be set in advance in the training apparatus 100.

The subject data is, for example, image data (e.g., CIFAR-10) containing images each including one of a plurality of types of subjects such as vehicles and animals. In a specific example of the embodiment, color images with an image size of 32×32 pixels are assumed. That is, the subject data is a vector data group of 32×32×3=3072 dimensional vectors (RGB values). The subject data may be referred to as “training data”.

The target cluster number is the target number of groups into which the plurality of items of subject data is aimed to be clustered by the training apparatus 100. The target cluster number is an integer equal to or greater than two, and is set in advance by the user. Specifically, the target cluster number may be flexibly set based on the user's prior knowledge according to the type of the subject data, such as “on the order of 10 clusters”, “up to five clusters”, and “between 10 and 20”.

The learning conditions include, for example, a DNN model architecture, architecture parameters, a loss function, and optimization parameters, etc. Examples of the DNN model architecture include ResNet, MobileNet, and EfficientNet. Examples of the architecture parameters include a number of hierarchies in the network, a number of nodes in each layer, a connection method between the layers, and a type of activation function used in each layer. The loss function includes, for example, a simple framework for contrastive learning of visual representations (SimCLR), a feature decorrelation (FD), and SimCLR+FD, which is a combination of SimCLR and FD. Examples of the optimization parameters include a type of an optimizer (e.g., momentum stochastic gradient descent (SGD), Adaptive Moment Estimation (Adam), etc.), a learning rate (or a learning rate schedule), the number of times of updating (the number of times of iterative training), a number of mini-batches (mini-batch size), and an intensity of Weight Decay. The learning conditions may include a first temperature parameter, a second temperature parameter, and a balancing parameter, to be described later.

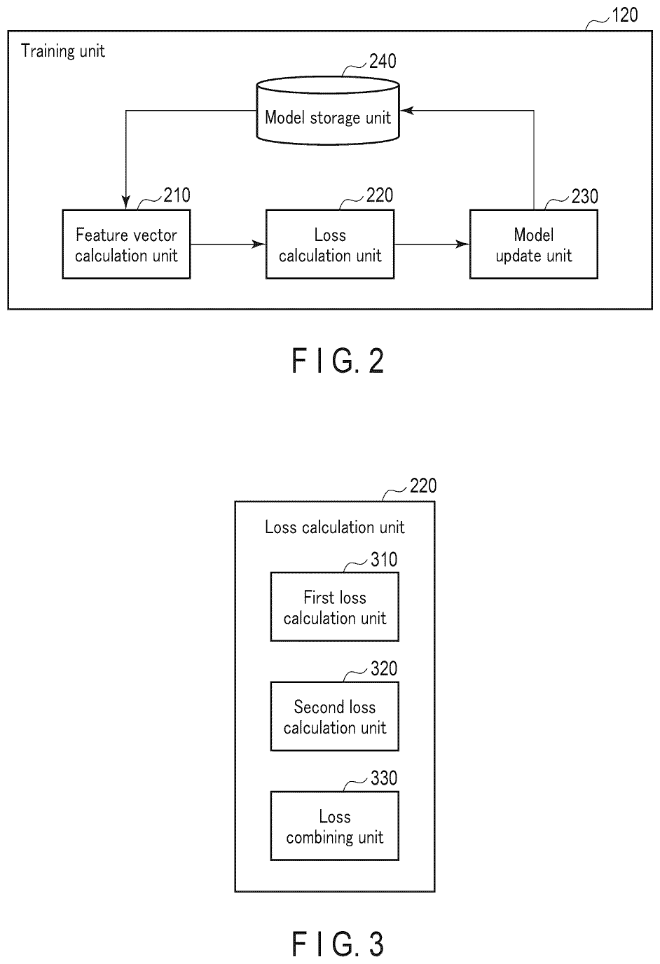

The training unit 120 receives, from the acquisition unit 110, the plurality of items of subject data and the learning conditions. The training unit 120 iteratively trains a learning model on the plurality of items of subject data based on the learning conditions by unsupervised learning. The training unit 120 outputs the learning model for which training has been completed as a trained model. The training unit 120 inputs a plurality of items of subject data to the learning model to output a plurality of feature vectors. The training unit 120 outputs, for each of the plurality of items of subject data, a feature vector calculated at the time of training to the feature cluster number estimation unit 130 and the display control unit 160. A specific configuration of the training unit 120 will be described with reference to FIG. 2.

FIG. 2 is a block diagram illustrating a specific configuration of the training unit 120. The training unit 120 includes a feature vector calculation unit 210, a loss calculation unit 220, a model update unit 230, and a model storage unit 240. In the description of each of the units to be given below, one of the plurality of items of subject data will be described.

The feature vector calculation unit 210 calculates a feature vector based on subject data. Specifically, the feature vector calculation unit 210 inputs subject data to a model stored in the model storage unit 240 to output (calculate) a feature vector. The feature vector calculation unit 210 outputs the feature vector to the loss calculation unit 220.

In the present embodiment, the feature vector data is calculated using data augmentation, which is employed for improving the learning precision of self-supervised learning. Example techniques of data augmentation of image data used in the present embodiment include brightness alteration, contrast alteration, Gaussian noise addition, inversion, and rotation. As a learning model used for feature vector calculation, a deep neural network (DNN) model that takes subject data (image data) as an input and outputs a feature vector is used. For such a DNN, the model architecture and the architecture parameters are set by learning conditions.

The feature vector calculation unit 210 may output a feature vector output from an output layer of the DNN, or an output from an intermediate layer several layers before the output layer may be configured as a feature vector. In the present embodiment, the feature vector is, for example, 128-dimensional vector data output from the output layer of the DNN.

The loss calculation unit 220 receives the feature vector from the feature vector calculation unit 210. The loss calculation unit 220 calculates a loss using the feature vector. The loss calculation unit 220 outputs the loss to the model update unit 230. A specific configuration of the loss calculation unit 220 will be described with reference to FIG. 3.

FIG. 3 is a block diagram illustrating a specific configuration of the loss calculation unit 220. The loss calculation unit 220 includes a first loss calculation unit 310, a second loss calculation unit 320, and a loss combining unit 330.

The first loss calculation unit 310 calculates a first loss using, for example, SimCLR, which is a technique of unsupervised learning. Using SimCLR, the first loss L₁ can be obtained by the following formulas (1) and (2):

$$— \text{?}$$

$$\text{?} \text{indicates text missing or illegible when filed}$$

$$— \text{?}$$

$$\text{?} \text{indicates text missing or illegible when filed}$$

In formula (1), “N” denotes a number of items of subject data, and “i” and “j” denote sequential numbers of two types of samples augmented by identical subject data. Since two types of samples obtained from a single item of subject data by data augmentation are used in SimCLR, the total number of samples is 2N.

Moreover, “1_{[k≠i]}” denotes a function that returns 1 if k≠1 and returns 0 if k=i, and “sim(A, B)” denotes a sim function (e.g., a cosine function) that outputs a greater value as the degree of similarity between A and B increases. Furthermore, “z” denotes an output vector (a feature vector) of the DNN, subscripts (e.g., i, j, and k) of “z” denote sequential numbers of the subject data, and “τ” denotes a temperature parameter relating to the first loss. In the present embodiment, τ will be referred to as a “first temperature parameter”. The first temperature parameter τ is configured to adjust a sensitivity of a numerical value output from the sim function, and is set in such a manner that the sensitivity increases as the value of the first temperature parameter τ decreases, and the sensitivity decreases as the value of the first temperature parameter τ increases.

In other words, the first loss calculation unit 310 calculates a first loss using a first technique (e.g., SimCLR) that yields a smaller loss as an error between a first feature vector and a second feature vector obtained from different items of subject data increases. The first technique includes a first temperature parameter for controlling a sensitivity of the error between the first feature vector and the second feature vector.

The second loss calculation unit 320 calculates the second loss using, for example, FD, which is a technique of unsupervised learning. Using FD, the second loss L₂ can be obtained by the following formula (3):

$$— \text{?}$$

$$\text{?} \text{indicates text missing or illegible when filed}$$

In formula (3), “f” denotes a set of output vectors (feature vectors) of the DNN, subscripts (e.g., “l” and “m”) of “f” denote indexes of elements of the feature vectors. For example, “fₗ” is an N-dimensional (or 2N-dimensional) vector in which l-th elements of the feature vectors are arrayed.

Also, “T” denotes transposition, and “τ₂” denotes a temperature parameter relating to the second loss. In the present embodiment, “τ₂” will be referred to as a “second temperature parameter”. The second temperature parameter τ₂ is configured to adjust a sensitivity of a numerical value calculated by an inner product of fₗ and a transposed matrix of fₗ and an inner product of fₗ and a transposed matrix of fₘ, and is set in such a manner that the sensitivity increases as the value of the second temperature parameter τ₂ decreases, and the sensitivity decreases as the value of the second temperature parameter τ₂ increases.

In other words, the second loss calculation unit 320 calculates the second loss using a second technique (e.g., FD) that yields a smaller loss as a correlation between elements of a feature vector decreases. Also, the second technique includes a second temperature parameter for controlling a sensitivity of the correlation between the elements of the feature vector.

The loss combining unit 330 calculates a combined loss (combinatorial loss) based on the first loss and the second loss. The combined loss L_{C} can be obtained by, for example, the following formula (4):

$$— \text{?}$$

$$\text{?} \text{indicates text missing or illegible when filed}$$

In the formula (4), “λ” denotes a hyperparameter, and is configured to adjust degrees of influence of the first loss L₁ and the second loss L₂. In the present embodiment, “λ” will be referred to as a “balancing parameter”, since it adjusts degrees of influence of the first loss L₁ and the second loss L₂. In the present embodiment, a training technique for minimizing the combined loss L_{C} will be referred to as “SimCLR+FD training”. The degree of influence may be rephrased as a “degree of importance”.

In other words, the loss combining unit 330 calculates a combined loss using a first loss, a second loss, and a balancing parameter for controlling a ratio between a degree of importance of the first loss and a degree of importance of the second loss. Hereinafter, the simple term “loss” refers to a “combined loss”.

The model update unit 230 receives a loss from the loss calculation unit 220. The model update unit 230 updates the learning model using the loss. The model update unit 230 outputs parameters of the updated learning model to the model storage unit 240.

Specifically, the model update unit 230 applies optimization parameters based on the loss to the learning model to update parameters of the learning model. The optimization parameters are set by the learning conditions.

The model storage unit 240 receives parameters for the learning model from the model update unit 230. The model storage unit 240 updates the learning model based on the received parameters, and stores the updated learning model.

The training unit 120 receives the updated learning conditions from the learning condition update unit 150. Upon receiving the updated learning conditions, the training unit 120 iteratively trains the learning model on the plurality of items of subject data based on the updated learning conditions by unsupervised learning. The items of the updated learning conditions include at least one of the first temperature parameter, the second temperature parameter, and the balancing parameter.

Upon receiving a termination instruction from the learning condition update unit 150, the training unit 120 terminates the entire training. Accordingly, the training unit 120 may be configured to output the learning model of which training has been completed under the current learning conditions as a trained model only after receiving a termination instruction. The training unit 120 may also be configured to output a plurality of feature vectors to the display control unit 160 only after receiving a termination instruction.

The feature cluster number estimation unit 130 receives a plurality of feature vectors, which are feature vectors of the respective items of subject data, from the training unit 120. The feature cluster number estimation unit 130 estimates a feature cluster number based on a plurality of feature vectors corresponding to the plurality of items of subject data. Also, the feature cluster number estimation unit 130 generates labels (feature cluster labels) corresponding to the number of estimated feature clusters. The feature cluster number estimation unit 130 outputs the feature cluster number to the learning condition update unit 150, and outputs the feature cluster labels to the label holding unit 140.

Specifically, the feature cluster number estimation unit 130 outputs, for a plurality of feature vectors, the feature cluster number using a technique of estimating the feature cluster number. Example techniques of estimating the feature cluster number include the elbow method, the silhouette analysis, and density-based spatial clustering of applications with noise (DBSCAN).

The label holding unit 140 receives the feature cluster labels from the feature cluster number estimation unit 130. The label holding unit 140 holds the feature cluster labels. The label holding unit 140 outputs, to the display control unit 160, at least feature cluster labels generated under last updated learning conditions.

Specifically, the label holding unit 140 receives feature cluster labels every time the learning conditions are updated, and hierarchically holds feature cluster labels for every update of the learning conditions. Hierarchical holding is synonymous with, for example, cumulative holding of feature cluster labels generated under the initial learning conditions and feature cluster labels generated under updated learning conditions. Typically, the feature cluster number varies before and after updating of the learning conditions. Accordingly, holding feature cluster labels for every update of the learning conditions may be beneficial for analyzing the plurality of items of subject data.

In other words, the label holding unit 140 cumulatively holds feature cluster labels every time the learning conditions are updated.

The learning condition update unit 150 receives, from the acquisition unit 110, a target cluster number and initial learning conditions, and receives, from the feature cluster number estimation unit 130, a feature cluster number. The learning condition update unit 150 updates the current learning conditions based on the target cluster number and the feature cluster number. The current learning conditions include initial learning conditions and learning conditions that have been updated at least once. The learning condition update unit 150 outputs the updated learning conditions to the training unit 120.

Specifically, the learning condition update unit 150 determines whether or not to update the learning conditions based on the target cluster number and the feature cluster number. If, for example, the target cluster number is a positive integer (natural number), the learning condition update unit 150 determines to not update the learning conditions if the following formula (5) is satisfied:

$$— \text{?}$$

$$\text{?} \text{indicates text missing or illegible when filed}$$

In formula (5), “CN_{c}” denotes a feature cluster number, “CNₜ” denotes a target cluster number, and “ε” denotes a convergence parameter. The convergence parameter ε is an integer equal to or greater than 0, and is set in advance to a given value by the user. If, for example, the convergence parameter ε is 0, the feature cluster number CN_{c} may not be identical to the target cluster number CNₜ, namely, the operation may not converge. By setting the convergence parameter ε to an integer equal to or greater than 1, a certain level of errors is permitted, thus allowing the operation to converge.

If, for example, the target cluster number is a natural number with an interval (e.g., from a lower-limit value and an upper-limit value), the learning condition update unit 150 determines to not update the learning conditions if the following formula (6) is satisfied:

$$— \text{?}$$

$$\text{?} \text{indicates text missing or illegible when filed}$$

In the formula (6), “CNₜₗ” denotes a lower-limit value of the target cluster number, and “CNₜᵤ” denotes an upper-limit value of the target cluster number.

In other words, the learning condition update unit 150 may determine whether or not the feature cluster number satisfies predetermined conditions. The predetermined conditions are, for example, that a difference between the feature cluster number and the target cluster number is equal to or smaller than a predetermined value (a convergence parameter), or that the feature cluster number is equal to or greater than the lower-limit value of the target cluster number and equal to or smaller than the upper-limit value of the target cluster number.

After determining to not update the learning conditions, the learning condition update unit 150 outputs a termination instruction to the training unit 120.

After determining to update the learning conditions, the learning condition update unit 150 updates the learning conditions by changing at least one of the first temperature parameter, the second temperature parameter, and the balancing parameter in the learning conditions.

The display control unit 160 receives, from the training unit 120, a plurality of feature vectors, which are feature vectors of the respective items of subject data, and receives, from the label holding unit 140, feature cluster labels generated from the feature vectors. Here, both of the feature vectors and the feature cluster labels have been generated under the last updated learning conditions. The display control unit 160 causes a correlation chart in which the feature vectors are expressed by multiple different components to be displayed. Also, the display control unit 160 may color-code the correlation chart using the feature cluster labels. The display control unit 160 outputs display data including the correlation chart to a display, etc. The display control unit 160 may cause the correlation chart to be displayed based on the feature cluster labels. Specifically, the display control unit 160 may cause a relationship between two feature cluster labels before and after updating of the learning conditions to be displayed on the correlation chart.

Specifically, the display control unit 160 transforms the 128-dimensional feature vectors into a two-dimensional or three-dimensional distribution (correlation chart) using a dimensionality reduction technique. Such a correlation chart is, for example, a scatter chart in which the feature vectors are expressed by points. Dimensionality reduction techniques include principal component analysis (PCA), t-distributed stochastic neighbor embedding (t-SNE), and uniform manifold approximation and projection (UMAP).

Also, the display control unit 160 may color-code the correlation chart using classification labels respectively applied in advance to the plurality of items of subject data. The classification labels are not used for training in the present embodiment. Moreover, the display control unit 160 may color-code the correlation chart by using, in combination, the classification labels and the feature cluster labels generated by the feature cluster number estimation unit 130. Furthermore, the display control unit 160 may output, on a display, display data containing the correlation chart and representative image data of the subject data corresponding to each cluster in the correlation chart.

The training apparatus 100 may include a memory and a processor. The memory stores, for example, various programs (e.g., training programs) relating to the operation of the training apparatus 100. By executing various programs stored in the memory, the processor implements various functions of the acquisition unit 110, the training unit 120, the feature cluster number estimation unit 130, the label holding unit 140, the learning condition update unit 150, and the display control unit 160.

The training apparatus 100 need not be configured of a physically single computer, and may be configured of a computer system (training system) including a plurality of computers that can be communicatively connected with one another via a wired connection or a network line, etc. Assignment of a series of processes of the present embodiment to the plurality of processors mounted on the plurality of computers may be suitably set. All the processors may be configured to execute all the processes in parallel, or one or more processors may be assigned with a specific process, such that the series of processes of the present embodiment are executed by the computer system as a whole. Typically, the function of the training unit 120 according to the present embodiment may be played by an external calculator.

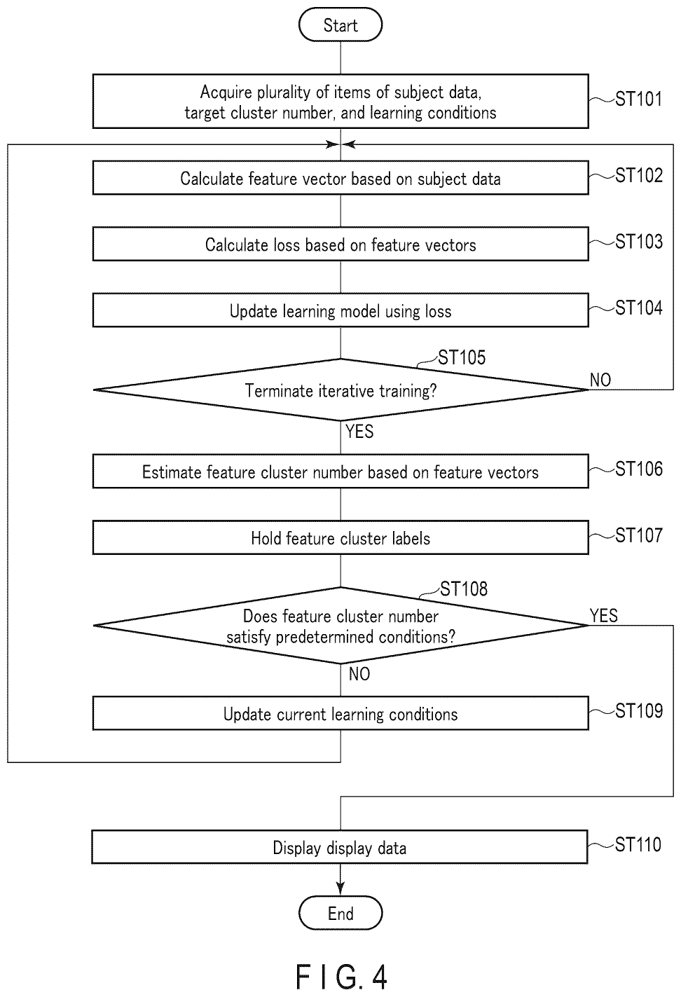

The configuration of the training apparatus 100 has been described above. Next, the operation of the training apparatus 100 according to the present embodiment will be described with reference to the flowchart of FIG. 4.

FIG. 4 is a flowchart illustrating an operation of the training apparatus 100 according to the embodiment. The processing of the flowchart in FIG. 4 is started by execution of a training program by the user.

### Step ST101

Upon execution of the training program by the training apparatus 100, the acquisition unit 110 acquires a plurality of items of subject data, a target cluster number, and learning conditions.

### Step ST102

After the acquisition unit 110 has acquired the plurality of items of subject data, the target cluster number, and the learning conditions, the feature vector calculation unit 210 calculates a feature vector based on the subject data.

### Step ST103

After the feature vector calculation unit 210 has calculated the feature vectors, the loss calculation unit 220 calculates a loss based on the feature vectors.

### Step ST104

After the loss calculation unit 220 has calculated the loss, the model update unit 230 updates the learning model using the loss.

More precisely, the processing from step ST102 to step ST104 is repeated for all of the plurality of items of subject data, thereby performing “iterative training”. A single cycle of processing for all the items of the subject data will be referred to as an “epoch”.

### Step ST105

After a cycle of processing for all the items of subject data, the training unit 120 determines whether or not to terminate the iterative training. For this determination, a predetermined number of epochs is used as termination conditions. If it is determined to not terminate the iterative training, the processing returns to step ST102. If it is determined to terminate the iterative training, the processing advances to step ST106.

### Step ST106

After the training unit 120 has determined to terminate the iterative training, the feature cluster number estimation unit 130 estimates a feature cluster number based on the feature vectors. Also, the feature cluster number estimation unit 130 generates a number of labels (feature cluster labels) corresponding to the feature cluster number.

### Step ST107

After the feature cluster number estimation unit 130 has estimated the feature cluster number, the label holding unit 140 holds the feature cluster labels.

### Step ST108

After the label holding unit 140 has held the labels, the learning condition update unit 150 determines whether or not the feature cluster number satisfies the predetermined conditions. The predetermined conditions are set for a target cluster number, as described above. If it is determined that the feature cluster number does not satisfy the predetermined conditions, the processing advances to step ST109, and if it is determined that the feature cluster number satisfies the predetermined conditions, the learning condition update unit 150 outputs a termination instruction to the training unit 120, and the processing advances to step ST110.

### Step ST109

If it is determined that the feature cluster number does not satisfy the predetermined conditions, the learning condition update unit 150 updates the current learning conditions. The learning condition update unit 150 outputs the updated learning conditions to the training unit 120. After step ST109, the processing returns to step ST102.

Specifically, the learning condition update unit 150 updates the learning conditions by changing at least one of the first temperature parameter, the second temperature parameter, and the balancing parameter in the learning conditions.

At step ST102, transitioned from step ST109, the feature vector calculation unit 210 calculates a feature vector based on the subject data under the updated learning conditions. At step ST103 and the subsequent steps, processing is similarly performed under the updated learning conditions.

### Step ST110

After the learning condition update unit 150 has determined that the feature cluster number satisfies the predetermined conditions, the display control unit 160 causes display data to be displayed. Specifically, the display control unit 160 causes display data containing a correlation chart (scatter chart) based on the feature vectors generated using the learning model in the last updated learning conditions to be displayed. After step ST110, the processing of the flowchart in FIG. 4 is terminated.

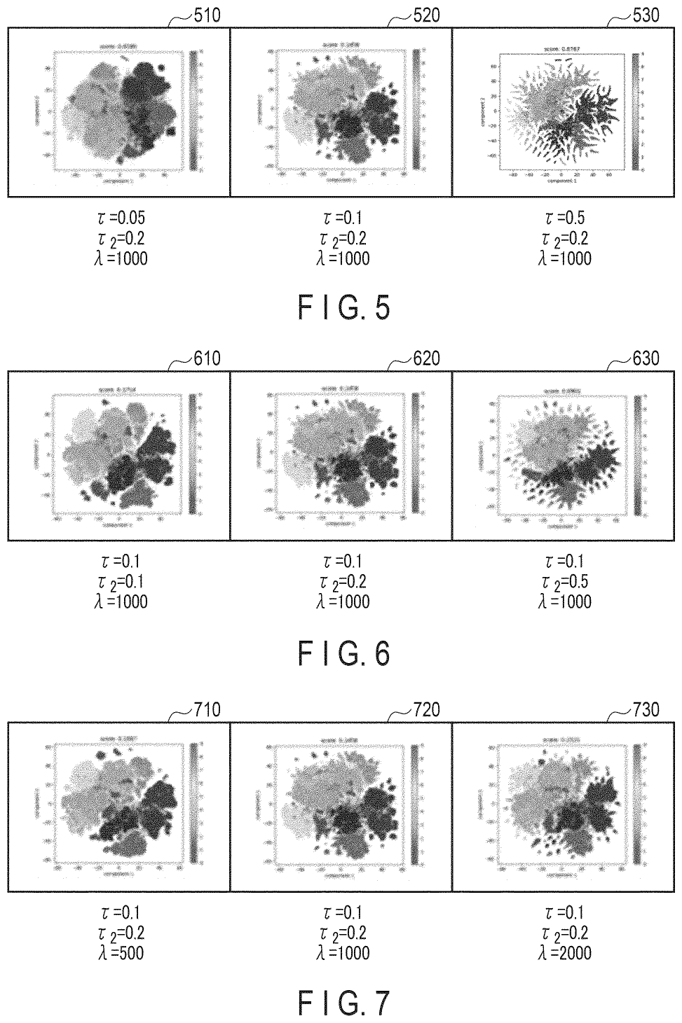

The operation of the training apparatus according to the embodiment has been described above. Next, a variation in display of the scatter chart by updating of the learning conditions will be described with reference to FIGS. 5 to 7.

FIG. 5 shows scatter charts in which feature vectors obtained by changing the first temperature parameter are visualized. FIG. 5 shows a scatter chart 510, a scatter chart 520, and a scatter chart 530. The scatter chart 510, the scatter chart 520, and the scatter chart 530 show feature vectors obtained by performing training with the first temperature parameter τ set to 0.05, 0.1, and 0.5, respectively, the second temperature parameter τ₂ set to 0.2, and the balancing parameter λ set to 1000. That is, the three scatter charts in FIG. 5 show the cases where the second temperature parameter τ₂ and the balancing parameter λ were fixed, and only the first temperature parameter τ was changed (updated). Hereinafter, the scatter chart 510 and the scatter chart 530 will be described, using the scatter chart 520 as the reference.

According to FIG. 5, in the scatter chart 510 showing the case where the first temperature parameter τ was decreased from 0.1 to 0.05, the number of small clusters occurring in the outer periphery of the distribution has decreased. It can thus be seen that the feature cluster number calculated by the parameters of the scatter chart 510 is smaller than the feature cluster number calculated by the parameters of the scatter chart 520.

In the scatter chart 530 showing the case where the first temperature parameter τ was increased from 0.1 to 0.5, the number of small clusters has increased over the entirety of the distribution. It can thus be seen that the feature cluster number calculated by the parameters of the scatter chart 530 is larger than the feature cluster number calculated by the parameters of the scatter chart 520.

FIG. 6 shows scatter charts in which feature vectors obtained by changing the second temperature parameter are visualized. FIG. 6 shows a scatter chart 610, a scatter chart 620, and a scatter chart 630. The scatter chart 610, the scatter chart 620, and the scatter chart 630 show feature vectors obtained by performing training with the second temperature parameter τ₂ set to 0.1, 0.2, and 0.5, respectively, the first temperature parameter τ set to 0.1, and the balancing parameter λ set to 1000. That is, the three scatter charts in FIG. 6 show the cases where the first temperature parameter τ and the balancing parameter λ were fixed, and only the second temperature parameter τ₂ was changed (updated). Hereinafter, the scatter chart 610 and the scatter chart 630 will be described, using the scatter chart 620 as the reference.

According to FIG. 6, in the scatter chart 610 showing the case where the first temperature parameter τ₂ was decreased from 0.2 to 0.1, the number of small clusters occurring in the outer periphery of the distribution has decreased. It can thus be seen that the feature cluster number calculated by the parameters of the scatter chart 610 is smaller than the feature cluster number calculated by the parameters of the scatter chart 620.

In the scatter chart 630 showing the case where the second temperature parameter τ₂ was increased from 0.2 to 0.5, the number of small clusters occurring in the outer periphery of the distribution has decreased. It can thus be seen that the feature cluster number calculated by the parameters of the scatter chart 630 is larger than the feature cluster number calculated by the parameters of the scatter chart 620.

FIG. 7 shows scatter charts in which feature vectors obtained by changing the balancing parameter are visualized. FIG. 7 shows a scatter chart 710, a scatter chart 720, and a scatter chart 730. The scatter chart 710, the scatter chart 720, and the scatter chart 730 show feature vectors obtained by performing training with the balancing parameter λ set to 500, 1000, and 2000, respectively, the first temperature parameter τ set to 0.1, and the second temperature parameter τ₂ set to 0.2. That is, the three scatter charts in FIG. 7 show the cases where the first temperature parameter τ and the second temperature parameter τ₂ were fixed, and only the balancing parameter λ was changed (updated). Hereinafter, the scatter chart 710 and the scatter chart 730 will be described, using the scatter chart 720 as the reference.

According to FIG. 7, in the scatter chart 710 showing the case where the balancing parameter λ was decreased from 1000 to 500, the number of small clusters occurring in the outer periphery of the distribution has decreased. It can thus be seen that the feature cluster number calculated by the parameters of the scatter chart 710 is smaller than the feature cluster number calculated by the parameters of the scatter chart 720.

In the scatter chart 730 showing the case where the balancing parameter λ was increased from 1000 to 2000, the number of small clusters occurring in the outer periphery of the distribution has increased. It can thus be seen that the feature cluster number calculated by the parameters of the scatter chart 730 is larger than the feature cluster number calculated by the parameters of the scatter chart 720.

In summary, the same parameters are set in each of the scatter chart 520, the scatter chart 620, and the scatter chart 720, which have been used as the references in the description of the scatter charts shown in FIGS. 5 to 7. Based on such references, it can be seen that the number of clusters increases by increasing one of the first temperature parameter τ, the second temperature parameter τ₂, and the balancing parameter λ. In this manner, the feature cluster number has a positive correlation with the first temperature parameter τ, the second temperature parameter τ₂, and the balancing parameter λ. That is, by adjusting the parameters based on a discrepancy (difference) between the feature cluster number and the target cluster number, it is possible to set learning conditions for efficiently approximating the feature cluster number to the target cluster number.

From the foregoing, it can be seen that the learning condition update unit 150 should update the learning conditions in such a manner that at least one of the first temperature parameter, the second temperature parameter, and the balancing parameter is increased if the feature cluster number is smaller than the target cluster number. Also, it can be seen that the learning condition update unit 150 should update the learning conditions in such a manner that at least one of the first temperature parameter, the second temperature parameter, and the balancing parameter is decreased if the feature cluster number is greater than the target cluster number.

The learning conditions need to be updated with parameters, etc. other than the first temperature parameter, the second temperature parameter, and the balancing parameter falling within an appropriate range. To cluster the subject data, which is CIFAR-10 consisting of 10 types of images in the present embodiment, into a number of groups greatly exceeding 10, there are cases where learning conditions greatly deviating from the normal ones are used. For example, in the scatter charts in FIGS. 5 to 7, the balancing parameter, which is generally set to approximately one, was set from 500 to 2000. That is, in the present embodiment, the balancing parameter is set to an extremely high value so as to place an importance on the second loss in the learning conditions, thus intentionally increasing the number of clusters.

Also, as is clear from the scatter charts shown in FIG. 5, the number of clusters can be increased and decreased by changing only the first temperature parameter; however, it is also possible to utilize the second temperature parameter and the balancing parameter in support thereof (in conjunction therewith). Since the second temperature parameter and the balancing parameter are correlated with the first temperature parameter, it is possible to perform control that is flexible about an increase/decrease in the number of clusters, and to obtain a feature amount preferable for clustering. That is, by using the second temperature parameter and the balancing parameter as well as the first temperature parameter, the precision of estimation of the feature cluster number by the feature cluster number estimation unit 130 is improved.

As described above, the training apparatus according to the embodiment is configured to acquire a plurality of items of subject data and a target cluster number, iteratively train a learning model on a plurality of items of subject data under learning conditions by unsupervised learning, estimate a feature cluster number based on a plurality of feature vectors corresponding to the plurality of items of subject data, and update the learning conditions based on the feature cluster number and the target cluster number.

Accordingly, with the training apparatus according to the embodiment capable of iteratively training the learning model by updating the learning conditions in such a manner that the feature cluster number reaches the target cluster number, it is possible to train a model preferable for classification into a target cluster number.

### Examples of Display Data

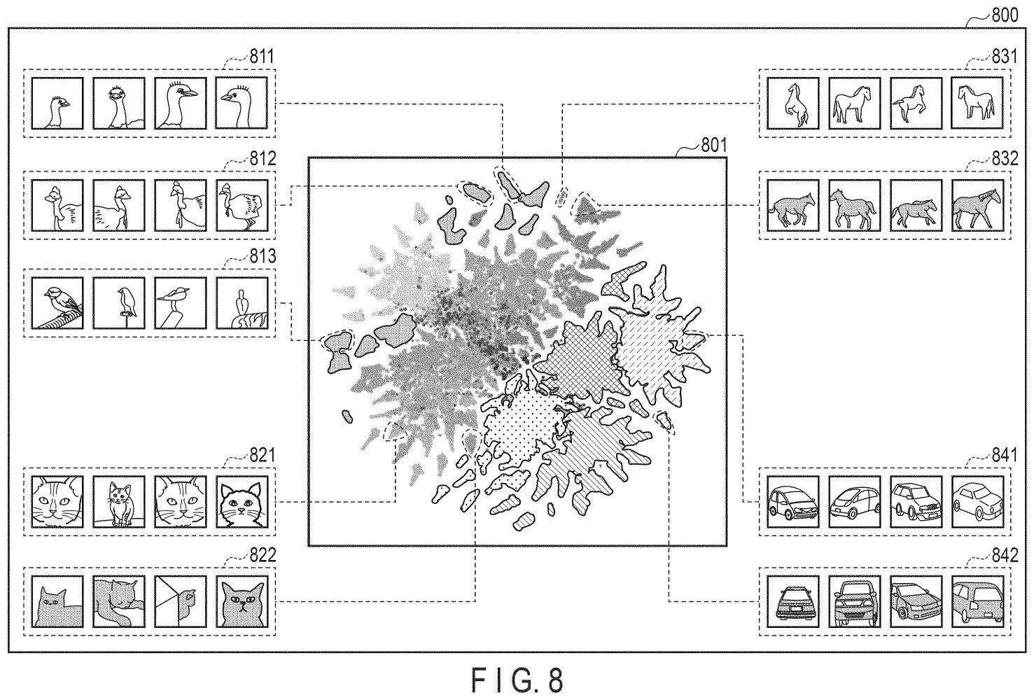

FIG. 8 shows an example of display data including a scatter chart in which feature vectors are visualized and a group of representative images of each cluster. Display data 800 in FIG. 8 contains a scatter chart 801 and a plurality of representative image groups 811 to 842. The scatter chart 801 has been obtained by adjusting the first temperature parameter, the second temperature parameter, and the balancing parameter in CIFAR-10, which is the subject data, using the technique of the embodiment in such a manner that the number of clusters becomes approximately 100. Color-coding of the scatter chart 801 is based on the classification labels of the ten classifications applied to CIFAR-10. It can be seen, from the scatter chart 801, that the 10 classifications are partitioned into differently colored regions, forming a larger number of clusters than the number of the classification labels.

Next, attention will be focused on representative image groups in each region of the scatter chart 801. For example, regions corresponding to the representative image groups 811, 812, and 813 are indicated by the same color, and denote the classification label “birds”. Also, these regions form mutually different clusters. The representative image group 811 shows the heads of ostriches, the representative image group 812 shows whole bodies of peacocks, and the representative image group 813 shows small birds perched on branches. That is, the clustering in the scatter chart 801 is performed in consideration of the size and the type of birds.

The regions respectively corresponding to the representative image group 821 and the representative image group 822, for example, are indicated by the same color, and denote the classification label “cats”. Also, these regions form mutually different clusters. The representative image group 821 shows white cats, and the representative image group 822 shows black cats. That is, the clustering in the scatter chart 801 is performed in consideration of the colors of the cats.

Also, the regions respectively corresponding to the representative image group 831 and the representative image group 832, for example, are indicated by the same color, and denote the classification label “horses”. Also, these regions form mutually different clusters. The representative image group 831 shows white horses, and the representative image group 832 shows black horses. That is, the clustering in the scatter chart 801 is performed in consideration of the coat colors of the horses.

Also, the regions respectively corresponding to the representative image group 841 and the representative image group 842, for example, are indicated by the same color, and denote the classification label “automobiles”. Also, these regions form mutually different clusters. The representative image group 841 shows white automobiles, and the representative image group 842 shows black automobiles. That is, the clustering in the scatter chart 801 is performed in consideration of the colors of the automobiles.

Accordingly, the training apparatus 100 according to the present embodiment may display a correlation chart (scatter chart) and a plurality of items of subject data for a region selected on the correlation chart. Also, the training apparatus 100 according to the present embodiment may display a correlation chart and subject data corresponding to a coordinate point selected on the correlation chart.

It can be seen, from FIG. 8, that the training apparatus 100 according to the present embodiment is capable of classifying data into specific types, compared to the labels applied to the subject data.

### Modification 1

In the above-described embodiment, a detailed discussion has not been made as to how the model is iteratively trained upon updating of the learning conditions. Typically, there is a method of initializing a model and iteratively training the initialized model upon updating of the learning conditions. However, this method is problematic in that the calculation time increases in proportion to the number of updates of the learning conditions. In particular, if the period of time until completion of the first training is long, a practical problem is highly likely to arise.

Accordingly, the training apparatus according to Modification 1 may be configured, upon updating of the learning conditions, to continue training the model by merely changing parameters relating to the target cluster number, without initializing the model. Also, the training apparatus according to Modification 1 may store a model trained to a certain level (e.g., a model preferable for 10 classifications), and read and train the stored model if the learning conditions are changed (e.g., to 20 classifications). In these cases, the training is performed on the subject data and is considered to be more effective than the case where a model is initialized and the initialized model is trained from scratch.

### Modification 2

In the above-described embodiment, a detailed discussion has not been made as to the process of iteratively training a model. Typically, there is a method of iteratively training a model by sequentially processing the subject data. This method is problematic in that the calculation time increases in proportion to the number of items of subject data.

Accordingly, the training apparatus according to Modification 2 may be configured to iteratively train the model by processing a plurality of items of subject data in parallel. The training apparatus according to Modification 2 may be configured to iteratively train the model by processing a plurality of items of subject data in parallel even if a target cluster number is given. With such training apparatuses configured to perform parallel processing, it is possible to reduce the calculation time compared to the sequential processing. The training apparatus according to Modification 2 may use the stored model discussed in Modification 1.

### Modification 3

In the training apparatus according to the embodiment, upon updating of learning conditions, the model is iteratively trained using all the items of subject data. However, if the number of samples belonging to a particular cluster is much smaller than the number of samples belonging to other clusters, it is often difficult to further divide the specific cluster.

Thus, the training apparatus according to Modification 3 may thin out the subject data based on the clusters at the time of updating of the learning conditions. Specifically, the training apparatus according to Modification 3 may iteratively train the model by excluding subject data of a particular cluster and using the remaining subject data. With the training apparatus according to Modification 3 with the above-described configuration, it is possible to reduce unnecessary processing, and to expect improvement in learning efficiency.

In other words, the learning condition update unit may update the learning conditions so as to exclude one or more items of subject data from the plurality of items of subject data, based on the number of items of subject data belonging to each of a plurality of clusters corresponding to the feature cluster number.

### Other Modifications

In the above-described embodiment, image data has been described as a specific example of subject data; however, the configuration is not limited thereto. For example, the subject data may be speech data, table data, and sensor data (e.g., acceleration and voltage data).

In the above-described embodiment, DNN has been described as a specific example of the machine learning model; however, the configuration is not limited thereto. For example, the machine learning model may be a model based on multiple regression analysis, a support vector machine (SVM), and decision tree analysis.

In the above-described embodiment, SimCLR+FD has been described as a specific example of the loss function; however, the configuration is not limited thereto. For example, the loss function may be calculated by a technique including at least one of the first temperature parameter, the second temperature parameter, and the balancing parameter. Specifically, as the first technique including the first temperature parameter, instance discrimination (ID), MOCO, BYOL SimCLR, etc., as well as SimCLR, may be used. Moreover, as a combination of the first technique and the second technique, IDFD, Barlow Twins, etc., as well as SimCLR+FD, may be used.

In the above-described embodiment, a single target cluster number is set by the user; however, the configuration is not limited thereto. For example, the user may set a plurality of target numbers of clusters. With the setting of a plurality of target numbers of clusters, a training apparatus according to another modification may be configured to apply a plurality of feature cluster labels to a single item of subject data.

### Hardware Configuration

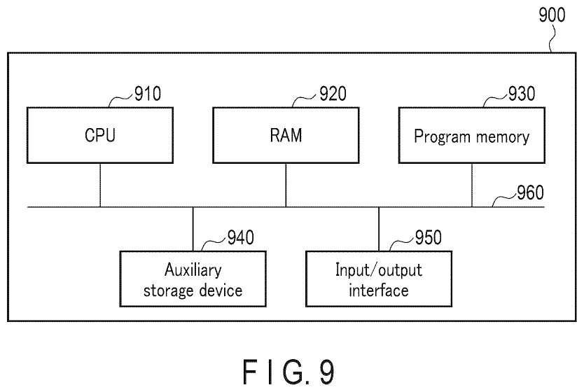

FIG. 9 is a block diagram illustrating a hardware configuration of a computer according to the embodiment. The computer 900 includes, as hardware, a central processing unit (CPU) 910, a random-access memory (RAM) 920, a program memory 930, an auxiliary storage device 940, and an input/output interface 950. The CPU 910 communicates with the RAM 920, the program memory 930, the auxiliary storage device 940, and the input/output interface 950 via the bus 960.

The CPU 910 is an example of a general-purpose processor. The RAM 920 is used as a working memory in the CPU 910. The RAM 920 includes a volatile memory such as a synchronous dynamic random-access memory (SDRAM).

The program memory 930 stores various programs including a training program. As the program memory 930, a read-only memory (ROM), part of the auxiliary storage device 940, or a combination thereof, for example, is used. The auxiliary storage device 940 stores data in a non-transitory manner. The auxiliary storage device 940 includes a non-volatile memory such as an HDD or an SSD.

The input/output interface 950 is an interface for connection or communication with another device. The input/output interface 950 is used for, for example, connection or communication between the training apparatus 100 and an input device (input unit), an output device, and a server, which are not illustrated.

The programs stored in the program memory 930 include computer-executable instructions. Upon execution by the CPU 910, the programs (computer-executable instructions) cause the CPU 910 to execute predetermined processing. For example, upon execution by the CPU 910, the training programs cause the CPU 910 to execute a series of processing described with reference to each component of the training apparatus 100.

The programs may be provided to the computer 900 in a state of being stored in a computer-readable storage medium. In this case, the computer 900 further includes a drive (not illustrated) configured to read data from the storage medium, and acquire programs from the storage medium. Examples of the storage medium include magnetic disks, optical disks (a CD-ROM, a CD-R, a DVD-ROM, a DVD-R, etc.), a magnetooptical disk (an MO), a semiconductor memory, etc. Moreover, programs may be stored in a server on a communication network, such that the computer 900 downloads the programs from a server using the input/output interface 950.

The processing described in the present embodiment is not limited to execution of programs by a general-purpose hardware processor such as the CPU 910, and may be performed by a dedicated hardware processor such as an application-specific integrated circuit (ASIC). The term “processing circuitry” or “processing unit” includes at least one general-purpose hardware processor, at least one dedicated hardware processor, or a combination of at least one general-purpose hardware processor and at least one dedicated hardware processor. In the example shown in FIG. 9, the CPU 910, the RAM 920, and the program memory 930 correspond to the processing circuitry.

According to the above-described embodiment, it is possible to train a model preferable for classification into a target cluster number.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training apparatus, comprising processing circuitry configured to:
acquire a plurality of items of subject data and a target cluster number;
iteratively train a learning model on the plurality of items of subject data by unsupervised learning based on learning conditions;
estimate a feature cluster number based on a plurality of feature vectors corresponding to the plurality of items of subject data; and
update the learning conditions based on the feature cluster number and the target cluster number.

2. The training apparatus according to claim 1, wherein
the processing circuitry is further configured to output the plurality of feature vectors by inputting the plurality of items of subject data to the learning model.

3. The training apparatus according to claim 2, wherein
the processing circuitry is further configured to:
calculate a first loss using a first technique which yields a smaller loss as an error between a first feature vector and a second feature vector obtained from different items of subject data included in the plurality of items of subject data increases, the first technique including a first temperature parameter for controlling a sensitivity of the error; and
update the learning conditions by changing the first temperature parameter.

4. The training apparatus according to claim 3, wherein
the processing circuitry is further configured to:
update the learning conditions in such a manner that the first temperature parameter is increased if the feature cluster number is smaller than the target cluster number; and
update the learning conditions in such a manner that the first temperature parameter is decreased if the feature cluster number is larger than the target cluster number.

5. The training apparatus according to claim 2, wherein
the processing circuitry is further configured to:
calculate a second loss using a second technique which yields a smaller loss as a correlation between feature vector elements decreases, the second technique including a second temperature parameter for controlling a sensitivity of the correlation; and
update the learning conditions by changing the second temperature parameter.

6. The training apparatus according to claim 5, wherein
the processing circuitry is further configured to:
update the learning conditions in such a manner that the second temperature parameter is increased if the feature cluster number is smaller than the target cluster number; and
update the learning conditions in such a manner that the second temperature parameter is decreased if the feature cluster number is larger than the target cluster number.

7. The training apparatus according to claim 2, wherein
the processing circuitry is further configured to:
calculate a first loss using a first technique which yields a smaller loss as an error between a first feature vector and a second feature vector obtained from different items of subject data included in the plurality of items of subject data increases, the first technique including a first temperature parameter for controlling a sensitivity of the error;
calculate a second loss using a second technique which yields a smaller loss as a correlation between feature vector elements decreases, the second technique including a second temperature parameter for controlling a sensitivity of the correlation; and
update the learning conditions by changing at least one of the first temperature parameter, the second temperature parameter, and a balancing parameter for adjusting degrees of influence of the first loss and the second loss.

8. The training apparatus according to claim 7, wherein
the processing circuitry is further configured to:
update the learning conditions in such a manner that at least one of the first temperature parameter, the second temperature parameter, and the balancing parameter is increased if the feature cluster number is smaller than the target cluster number; and
update the learning conditions in such a manner that at least one of the first temperature parameter, the second temperature parameter, and the balancing parameter is decreased if the feature cluster number is larger than the target cluster number.

9. The training apparatus according to claim 1, wherein
the processing circuitry is further configured to:
determine whether or not the feature cluster number satisfies predetermined conditions;
terminate the iterative training of the learning model if it is determined that the predetermined conditions are satisfied; and
change the learning conditions if it is determined that the predetermined conditions are not satisfied.

10. The training apparatus according to claim 9, wherein
the predetermined conditions are that a difference between the feature cluster number and the target cluster number is equal to or smaller than a predetermined value, or that the feature cluster number is equal to or greater than a lower-limit value of the target cluster number and equal to or smaller than an upper-limit value of the target cluster number.

11. The training apparatus according to claim 1, wherein
the processing circuitry is further configured to update the learning conditions so as to exclude one or more items of subject data from the plurality of items of subject data, based on the number of items of subject data belonging to each of a plurality of clusters corresponding to the feature cluster number.

12. The training apparatus according to claim 1, wherein
the processing circuitry is further configured to:
generate one or more feature cluster labels corresponding to the feature cluster number; and
cumulatively hold the one or more feature cluster labels every time the learning conditions are updated.

13. The training apparatus according to claim 1, wherein the processing circuitry is further configured to cause a correlation chart expressing the feature vectors by different components to be displayed.

14. The training apparatus according to claim 13, wherein
the processing circuitry is further configured to cause the correlation chart and subject data corresponding to a coordinate point selected on the correlation chart to be displayed.

15. The training apparatus according to claim 13, wherein
the processing circuitry is further configured to cause the correlation chart and a plurality of items of training data included in a cluster corresponding to a region selected on the correlation chart to be displayed.

16. A training method, comprising:
acquiring a plurality of items of subject data and a target cluster number;
iteratively training a learning model on the plurality of items of subject data by unsupervised learning based on learning conditions;
estimating a feature cluster number based on a plurality of feature vectors corresponding to the plurality of items of subject data; and
updating the learning conditions based on the feature cluster number and the target cluster number.

17. A non-transitory computer-readable storage medium storing a program for causing a computer to execute processing comprising:
acquiring a plurality of items of subject data and a target cluster number;
iteratively training a learning model on the plurality of items of subject data by unsupervised learning based on learning conditions;
estimating a feature cluster number based on a plurality of feature vectors corresponding to the plurality of items of subject data; and
updating the learning conditions based on the feature cluster number and the target cluster number.
